(19) United States
(12) Patent Application Publication
(10) Pub. No.: US 2006/0064629 A1
(43) Pub. Date: Mar. 23, 2006

(54) Device and method of updating service information in the same

(75) Inventor: Ki-won Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/194,459

(22) Filed: Aug. 2, 2005

(30) Foreign Application Priority Data
Sep. 20, 2004 (KR) 10-2004-0074935

(51) Int. Cl. H04N 7/173; G06F 11/00

(52) U.S. Cl. 714/798; 725/107

(57) ABSTRACT

A method and device for determining whether to update service information based on section data. The device includes a CRC data generator for generating a CRC data by using predetermined fields of fields constituting received section data, a comparator for determining whether there exists the same CRC data as the generated CRC data, and a microcomputer, if there is no same data, determining that updated service information is received. Accordingly, whether to update the service information is determined based on the received section data.

### CROSS-REFERENCE TO RELATED APPLICATIONS

This application claims priority from Korean Patent Application No. 10-2004-0074935, filed on Sep. 20, 2004, in the Korean Intellectual Property Office, the disclosure of which is incorporated herein by reference in its entirety.

### BACKGROUND OF THE INVENTION

1. Field of the Invention

Apparatuses and methods consistent with the present invention relate to Out-of-Band (OOB) Service Information (SI) data of the OpenCable specifications, and more particularly, determining whether to update SI by using the OOB SI data and a TV capable of determining whether to update SI.

2. Description of the Related Art

Most countries select one of many standards described by various associations that is most suitable to the broadcasting environments of each respective country. More specifically, there are international associations for broadcasting, such as the Society of Motion Picture and Television Engineers (SMPTE), the European Broadcasting Unit (EBU), the Audio Engineering Society (AES), etc.; international associations for source encoding, such as the Moving Picture Experts Group (MPEG), the International Telecommunication Union-Telecommunication Standardization Sector (ITU-T) SG16, etc.; and international associations for channel encoding, such as the International Telecommunication Union-Radio Communication Sector (ITU-R) SG4 (satellite), SG11 (terrestrial), ITU-SG9 (cable).

Various digital cable TV systems include OpenCable, as used in the U.S., Digital Video Broadcasting-Cable (DVB-C), as used in Europe, and Integrated Services Digital Broadcasting-Cable (ISDB-C), as used in Japan. The following Table 1 shows a difference between the OpenCable and DVB-C systems.

TABLE 1

| | Open Cable | DVB-C |
|---|---|---|
| Video Compression | MPEG-2 MP@ML/HL | MPEG-2 MP@ML |
| Standard | | |
| Audio Compression | Dolby AC-3 | MPEG-2 AAC |
| Standard | | |
| Multiplexing Standard | MPEG-2 Transport | MPEG-2 Transport |
| Security module Interface | POD Interface | Common Interface |
| Copy Protocol | POD I/F CP | IEE 1394/5C CP |
| | IEEE 1394/5C CP | (Option) |
| Broadcasting Protocol | OOB SI: main | DVB-SI |
| | In-Band PSIP: Option | |

As shown in Table 1, the broadcasting protocol of the OpenCable specifications is OOB SI. When a TV adopts the OpenCable standard, the TV obtains SI composed of a variety of channel map data (channel information) and network information via an OOB path, and performs channel navigation based on the obtained service information.

The TV repeatedly receives sections constituting the OOB SI. A revision detection descriptor is used to perceive whether there is a change in the OOB SI constituted by the sections. In other words, the TV uses the revision detection descriptor to perceive version information. However, a profile of the Society of Cable Telecommunications Engineers (SCTE) 65, which is an OOB SI standard of the OpenCable specifications, does not include the revision detection descriptor. The version information is not included in a different descriptor other than the revision detection descriptor.

FIG. 1 illustrates a conventional process of updating service information in a TV.

In operation S100, a TV deletes all of service information stored therein. In order to update the service information, first required is the operation of deleting all of service information previously stored therein. In operation S102, the TV parses a plurality of sections transmitted from a transmitting side and thereby generates single service information.

In operation S104, the TV updates the service information by using the generated service information. In the conventional art, the process of updating the service information comprises deleting the service information previously stored and newly generating service information by using received sections. The reason that two operations are required to update the service information is that the TV is incapable of discriminating between the previously stored service information and the newly received information because the profile of SCTE65 does not provide the version information.

As described above, the TV receives updated service information but does not know if the received service information is the updated service information. Also, the TV cannot update the service information unless the previously stored service information is discarded. Additionally, the TV is more likely subjected to a load when updating the service information based on the received service information. Accordingly, there is a demand for a method that can compare the previously stored service information and the received service information.

### SUMMARY OF THE INVENTION

An aspect of the present invention is to provide a method of perceiving whether there is a change in service information based on received OOB SI section data.

Another aspect of the present invention is to provide a method of updating service information which is stored only when there is change in OOB SI section data, thereby reducing a load exerted to a TV.

The above aspects are achieved by providing a method for determining whether to update a service information constituting a section data and updating the service information. The method comprises generating a Cyclic Redundancy Check (CRC) data by using predetermined fields constituting received section data, determining whether there exists the same CRC data as the generated CRC data, and if the generated CRC data is different, determining that updated service information is received.

Further, the above aspects are achieved by providing a device for determining whether to update a service information constituting a section data and updating the service information. The device comprises a CRC data generator for generating a CRC data by using predetermined fields constituting received section data, a comparator for determining whether existing CRC data is the same as the generated CRC data, and a microcomputer which determines that an updated service information is received.

### BRIEF DESCRIPTION OF THE DRAWINGS

The above and other aspects of the present invention become apparent by describing an exemplary embodiment of the present invention in greater detail with reference to the accompanying drawings, in which:

FIG. 1 is a flowchart showing a process of updating service information in a conventional OpenCable television;

FIG. 2 is a view showing a structure of OOB SI section used in the OpenCable system;

FIG. 3 is a block diagram showing an OpenCable television according to an exemplary embodiment of the present invention;

FIG. 4 is a flowchart showing a process of generating service information according to an exemplary embodiment of the present invention; and

FIG. 5 is a flowchart showing a process of updating service information according to an exemplary embodiment of the present invention.

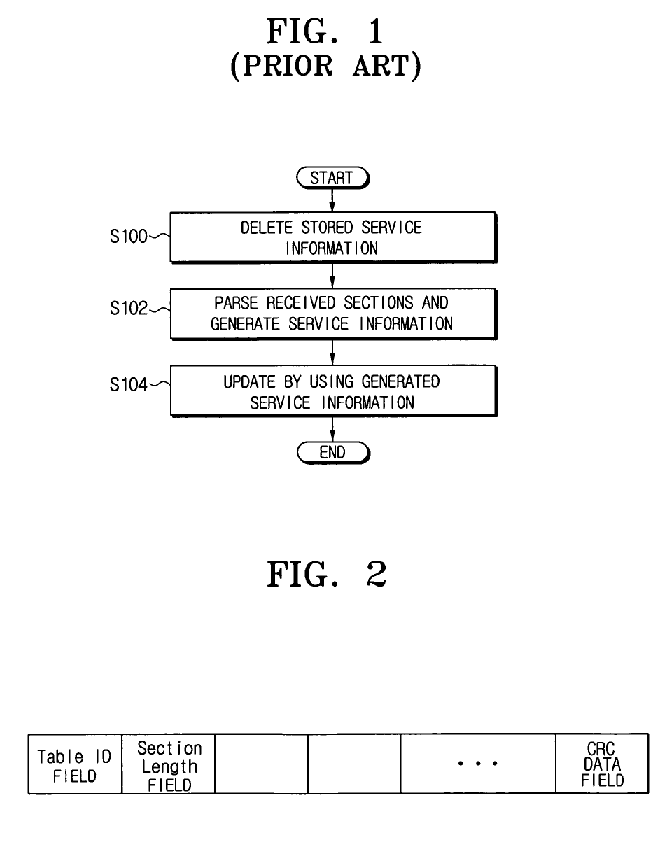

In the drawings, like reference numerals refer to like features and structures.

### DETAILED DESCRIPTION OF EXEMPLARY EMBODIMENTS

Hereinafter, operation of a television according to the present invention, which receives signals according to the OpenCable specifications, will now be described in greater detail with reference to the accompanying drawings.

FIG. 2 is a view showing a structure of an OOB SI section received at a TV. In general, a transmitting side segments service information and transmits the segmented service information to the TV by use of a plurality of sections. In other words, the TV receives the plurality of sections and thereby obtains the service information.

As shown in FIG. 2, the OOB SI section includes a table identifier field, a section length field, and a CRC data field. The table identifier field is composed of 8 bits, the section length field of 12 bits and the CRC data field of 32 bits. The OOB SI consists of a plurality of tables. A table identifier, in the table identifier field, is a dedicated identifier for discriminating the plurality of tables. The plurality of tables used in the TV include a Network Information Table (NIT), a Network Text Table (NTT), a Short-form Virtual Channel Table (S-VCT), and a System Time Table (STT). Detailed descriptions about the respective tables are omitted.

The OOB SI section is composed of 5012 bits. The OOB SI section uses 4096 bits for fields other than the CRC data field, such as a table identifier field, section length field, etc., to transmit information constituting a corresponding table. The CRC data is generated by using the fields other than the CRC data field to check an error occurring in the OOB SI section during the transmission of sections. The transmitting side records on the fields other than the table ID field, the section length field and the CRC data field information corresponding to the table identifier.

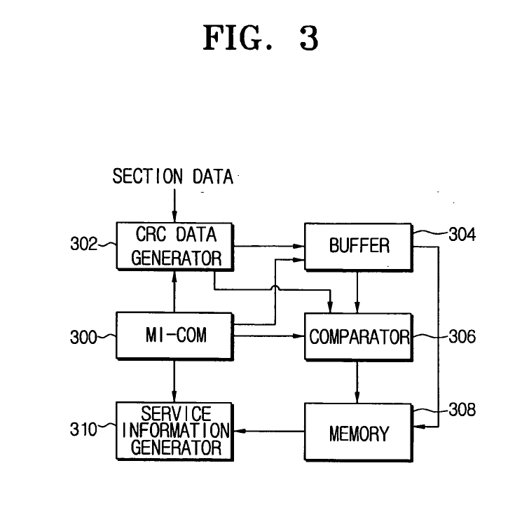

FIG. 3 is a block diagram showing a TV according to an exemplary embodiment of the present invention. The TV comprises a microcomputer 300, a CRC data generator 302, a buffer 304, a comparator 306, a memory 308 and a service information generator 310. It is apparent that other components can be included in the TV.

The microcomputer 300 controls the components of the TV. The CRC data generator 302 receives section data. The CRC data generator 302 removes CRC data from the received section data according to a control command from the microcomputer 300. The TV determines the presence/absence of error in the received section data by using the CRC data. The CRC data generator 302 generates CRC data of CRC data-removed section data.

The buffer 304 receives from the CRC data generator 302 the CRC data-removed section data and the CRC data of the CRC data-removed section data according to a control command from the microcomputer 300, and stores the data.

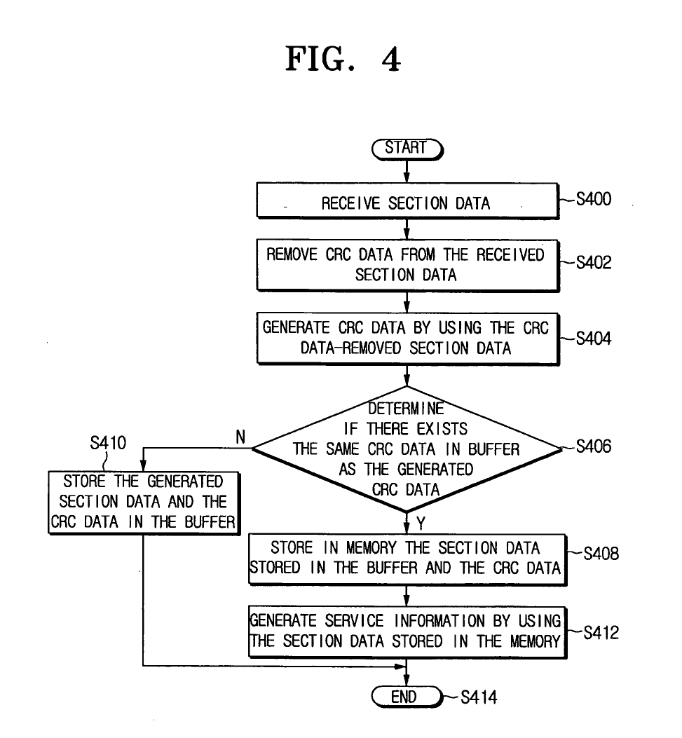

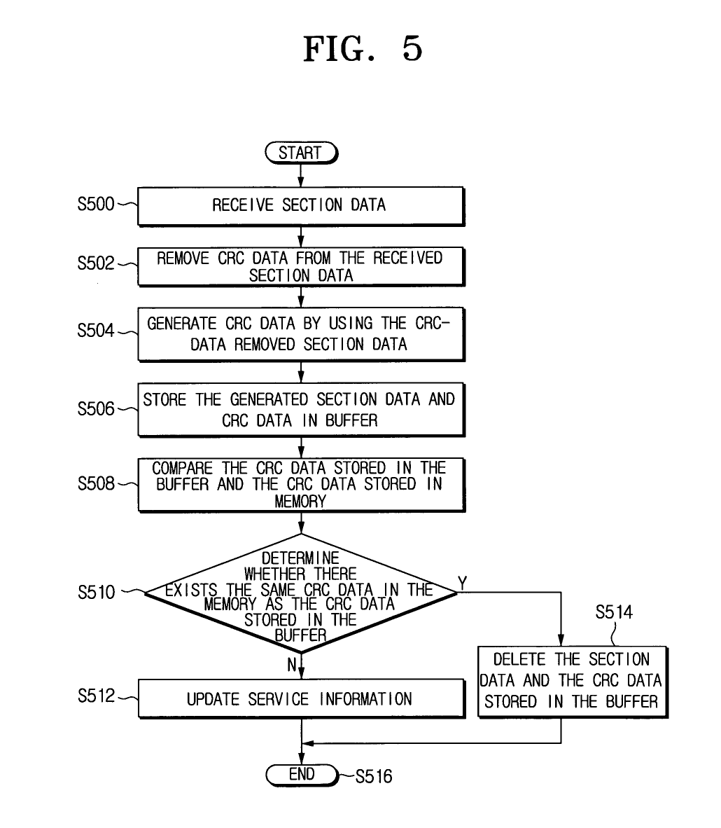

The comparator 306 compares the CRC data previously stored in the buffer 304 and the CRC data transmitted from the CRC data generator 302. Also, the comparator 306 compares the CRC data stored in the buffer 304 and the CRC data stored in the memory 308. The operation of the comparator 306 will be described below in detail with reference to FIGS. 4 and 5.

The memory 308 receives and stores from the buffer 304 the CRC data-removed section data and the CRC data of the CRC data-removed section data. The service information generator 310 generates service information by using the CRC data-removed section data stored in the memory 308 according to a control command from the microcomputer 300.

FIG. 4 is a flowchart showing a process of generating service information by using received section data according to an exemplary embodiment of the present invention. Hereinafter, the process of generating service information by using received section data according to an exemplary embodiment of the present invention will be described in detail with reference to FIG. 4.

In operation S400, a TV receives section data. As described above, a transmitting side transmits OOB SI to the TV by using a plurality of sections.

In operation S402, the TV removes CRC data from the received section data. The TV removes the CRC data because an error may have occurred during the data transmission and thus the CRC data may be unreliable data. Also, the CRC data is unnecessary in the process of generating the service information by using the received section data.

In operation S404, the TV generates CRC data by using the CRC data-removed section data. A length of the generated CRC data is composed of 32 bits as shown in FIG. 2. Although FIG. 4 illustrates the operation S402 and the operation S404 as separate processes, they may be incorporated into one process according to a user's setting, in an alternative exemplary embodiment.

In operation S406, the TV determines if there exists the same CRC data in the buffer as that generated at the operation S404. If there exists the same CRC data in the buffer, the process moves to operation S408, and if not, the process moves to operation S410.

If there exists the same CRC data in the buffer as the generated CRC data, it is determined that the section data received at the operation S400 has been previously received. This is because the TV does not need to store the same section data in the buffer repeatedly.

In operation S410, the TV stores in the buffer the CRC data-removed section data of operation of S402 and the CRC data generated at operation S404.

In operation S408, the TV transmits the CRC data-removed section data and the CRC data stored in the buffer to a memory. The memory receives and stores the CRC data-removed section data and the CRC data from the buffer. In an exemplary embodiment, if the generated CRC data is the same as the CRC data stored in the buffer, the process moves to the operation S408. However, according to another exemplary embodiment, the TV counts the number of generations of the same CRC data as the CRC data stored in the buffer according to a user's setting. If the counted number exceeds a predetermined set value, the TV performs the operation S408.

In operation S412, the TV generates service information by using the section data stored in the memory. During the above process, the TV generates the service information in the early stage. Hereinafter, a process of updating the service information will be described.

FIG. 5 is a flowchart showing a process of updating service information by a TV according to an exemplary embodiment of the present invention. The process of updating service information by the TV will now be described in greater detail with reference to FIG. 5.

In operation S500, the TV receives section data. As described above, a transmitting side transmits OOB SI to the TV by using a plurality of sections.

In operation S502, the TV removes CRC data from the received section data. This is because an error may have occurred during the transmission and thus the data is unreliable. Also, the CRC data is unnecessary in generating service information by using the received section data.

In operation S504, the TV generates CRC data by using the CRC data-removed section data. A length of the generated CRC data is composed of 32 bits as shown in FIG. 2. Although the flowchart of FIG. 5 describes the operations S502 and S504 as separate processes, it is apparent that they are incorporated into one process according to a user's setting, in an alternate exemplary embodiment.

In operation S506, the TV stores, in the buffer, the CRC data-removed section data at the operation S502 and the CRC data generated at the operation S504. In operation S508, the TV compares the CRC data stored in the buffer and the CRC data stored in the memory in sequence.

In operation S510, the TV determines whether there exists the same CRC data in the memory as the CRC data in the buffer. If the CRC data is different, the process moves to the operation S512, and if there exists the same CRC data, the process moves to the operation S514. If there exists the same CRC data, it means that the section data received at the operation S500 is the same as previously received. If there is different CRC data, it means that the section data received at the operation S500 is updated section data.

In operation S512, the TV updates service information by using the section data received at the operation of S500 and section data subsequently received after the operation of S500. The process of updating the service information is the same as shown in FIG. 4. The service information is updated by deleting previously generated service information and using newly received section data.

In operation S514, the TV deletes the section data and the CRC data which are stored in the buffer. The section data and the CRC data received at the operation S500 and the section data and the CRC data stored in the buffer are all deleted. As described above, in spite of absence of version information, it is possible to determine whether channel information is updated or not based on the received section data.

In an additional exemplary embodiment, if it is determined that updated service information has been received, the TV continues to receive additional section data until additional generated CRC data is the same as the stored CRC data. When the same CRC data is generated, service information is generated by using section data except for section data having the same CRC data. Then the service information is updated by using the generated service information

Although FIGS. 2 to 5 illustrate the operations performed by a TV adopting the OpenCable system, this should not be considered as limiting. Any device, although a receiving side thereof cannot receive version information, can determine whether service information has been updated or not through the above-described process. Also, although in a described embodiment, the CRC data is compared to determine whether the service information has been updated, as shown in FIGS. 3 to 5, it is also possible to compare the section data according to a user's setting.

As described above, in spite of absence of the version information, it is determined whether there is a change in service information by using the received section data. Whether there is a change in the service information is determined through the process of generating CRC data from the received section data and comparing the generated CRC data with previous CRC data. Also, since the service information is updated only when there is a change in the service information, a load exerted to the cable TV can be reduced.

The foregoing embodiment and advantages are merely exemplary and are not to be construed as limiting the present invention. The description of the present invention is intended to be illustrative, and not to limit the scope of the claims. Many alternatives, modifications, and variations will be apparent to those skilled in the art.

What is claimed is:

1. A method for determining whether to update service information constituting section data and updating the service information, the method comprising:
generating Cyclic Redundancy Check (CRC) data by using predetermined fields among fields which constitute received section data;
determining whether the generated CRC data is the same as existing CRC data; and
determining that updated service information is received if a difference exists between the generated CRC data and the existing CRC data.

2. The method as claimed in claim 1, wherein the predetermined fields are fields other than a CRC data field among the fields which constitute the received section data.

3. The method as claimed in claim 1, discarding the received section data if the generated CRC data is the same as the existing CRC data.

4. The method as claimed in claim 1, further comprising storing the generated CRC data in a buffer if the generated CRC data is different from the existing CRC data.

5. The method as claimed in claim 4, further comprising:
if it is determined that the updated service information has been received, receiving additional section data until additional generated CRC data is the same as said stored CRC data;
if the additional generated CRC data is the same as the stored CRC data, generating service information by using section data other than section data having the same CRC data; and
updating the service information by using the generated service information.

6. The method as claimed in claim 1, further comprising counting a number of generations of CRC data which are determined to be the same as the existing CRC data, and when the number exceeds a predetermined value storing the existing CRC data.

7. The method as claimed in claim 1, wherein the service information includes channel information.

8. A device for determining whether to update a service information constituting section data and updating the service information, the device comprising:
a Cyclic Redundancy Check (CRC) data generator which generates CRC data by using predetermined fields among fields which constitute a received section data;
a comparator which determines whether the generated CRC data is the same as existing CRC data; and
a microcomputer which determines that updated service information has been received if the generated CRC data is different from the existing CRC data.

9. The device as claimed in claim 8, wherein the predetermined fields are fields other than a CRC data field among the fields which constitute the received section data.

10. The device as claimed in claim 8, wherein the microcomputer discards the received section data if the generated CRC data is the same as the existing CRC data.

11. The device as claimed in claim 8, further comprising:
a buffer which temporarily stores the generated CRC data and data configured by the predetermined fields; and
a memory in which the existing CRC data has been previously stored.

12. The device as claimed in claim 11, further comprising a service information generator which generates the service information by using data configured by the predetermined fields stored in the memory according to a control command from the microcomputer

13. The device as claimed in claim 11, wherein the microcomputer discards the existing data stored in the memory if the updated service information is received.

14. The device as claimed in claim 13, wherein if the comparator determines that the existing CRC data and the generated CRC data are the same, the comparator transmits the existing CRC data and the data configured by the predetermined fields to the memory.

15. The device as claimed in claim 8, wherein the service information includes channel information.
